(19) United States
(12) Patent Application Publication
(10) Pub. No.: US 2005/0234594 A1
(43) Pub. Date: Oct. 20, 2005

(54) Self-running cleaner

(75) Inventor: Naoya Uehigashi, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/105,800

(22) Filed: Apr. 14, 2005

(30) Foreign Application Priority Data
Apr. 16, 2004 (JP) 2004-122088

(51) Int. Cl. G06F 19/00

(52) U.S. Cl. 700/245; 318/568.12

(57) ABSTRACT

A self-running cleaner that can be operated longer at reduced cost includes a cleaning unit for suction of dust and dirt, a storage battery supplying power consumed by the cleaning unit, a solar cell recharging the storage battery, a camera detecting illuminance of a plurality of sites, a running unit for travel, and a control unit controlling the running unit so as to move, based on the illuminance detected by the camera, to a site where illuminance is highest among the sites where illuminance is detected by the camera.

### BACKGROUND OF THE INVENTION

1. Field of the Invention

The present invention relates to self-running cleaners, particularly, a self-running cleaner capable of automatic recharging.

2. Description of the Background Art

As disclosed in Japanese Patent Laying-Open No. 09-299288, a conventional lower part suction type automatic electric vacuum cleaner is absent of a hose available in a conventional electric vacuum cleaner, and uses a rechargeable battery instead of a power cord. An intake port is provided at the lower back side of the main body of the electric vacuum cleaner. A lid with a magnet is provided at the dust bag. The motor for suction is attached in a vertical manner. A motor for driving power is attached at the front wheel tire. A control panel is provided at the area of the power switch.

In accordance with the invention disclosed therein, the cleaning job is rendered automatic to allow cleaning to be conducted conveniently and efficiently.

Japanese Patent Laying-Open No. 2003-204910 discloses an electric vacuum cleaner including a main body having an electric fan for generating an intake air stream and a storage battery for driving the electric fan, an operation unit allowing input operation of the electric fan, a floor suction unit to draw in dust, and a charger for recharging the storage battery. The storage battery is rechargeable by a solar cell.

In accordance with the invention disclosed therein, power can be supplied continuously by sunlight or indoor lighting to increase the operating time of a cordless electric vacuum cleaner.

The invention disclosed in Japanese Patent Laying-Open No. 09-299288 is disadvantageous in that operation for a long period of time is difficult using a small battery. When the cleaner is to be operated using a small battery, recharging must be conducted frequently. Such recharging will degrade the efficiency of the cleaner operation.

The invention disclosed in Japanese Patent Laying-Open No. 2003-204910 is disadvantageous in that it is difficult to increase the operating time significantly. In the case where the storage battery is recharged using a solar cell, the illuminance of light directed to the solar cell greatly affects the charging efficiency. A cleaner located indoors generally cannot have light of sufficient intensity applied. Therefore, the charging efficiency towards the battery cannot be increased significantly. As a result, the power consumed by the cleaner will often exceed the power recharged through the solar cell. Thus, the operating time cannot be readily increased significantly.

### SUMMARY OF THE INVENTION

In view of the foregoing, an object of the present invention is to provide a self-running cleaner that can have the operating time further increased and the cost decreased.

According to an aspect of the present invention, a self-running cleaner includes a cleaning unit for suction of dust and dirt, a storage battery supplying power consumed by the cleaning unit, a solar cell recharging the storage battery, a device for travel, a timer identifying time, a device detecting illuminance through output of charge according to illuminance determined corresponding to the color of reflected light, a device controlling the device for travel such that the device detecting illuminance faces, at a time determined in advance as when the illuminance exceeds a predetermined value, a plurality of directions where the luminance is increased, according to the time identified by the timer, and a device controlling the device for travel so as to move, based on the illuminance detected by the device detecting illuminance, to a site where the illuminance is highest among the sites where the illuminance is detected by the device detecting illuminance.

According to the present aspect, a self-running cleaner that can have the operating time particularly increased and the cost reduced can be provided.

According to another aspect of the present invention, a self-running cleaner includes a cleaning unit for suction of dust and dirt, a storage battery supplying power consumed by the cleaning unit, a solar cell recharging the storage battery, a device detecting illuminance of a plurality of sites, a device for travel, and a first control device to control the device for travel so as to move, based on illuminance detected by the device detecting illuminance, to a site of highest illuminance among sites where illuminance is detected by the device detecting illuminance.

As a result, a self-running cleaner that can have the operating time further increased and the cost reduced can be provided.

The device detecting illuminance preferably includes a device providing charge according to illuminance of reflected light, and a second control device to control the device for travel such that the device providing charge faces a plurality of directions.

As a result, a self-running cleaner dust that can have the operating time further increased and the cost reduced can be provided.

Alternatively, the illuminance of reflected light is preferably illuminance determined corresponding to the color of the reflected light.

As a result, a self-running cleaner that can have the operating time further increased and the cost reduced can be provided.

The self-running cleaner set forth above preferably includes a timer identifying the time. Furthermore, the second control device preferably includes a device controlling the device for travel so as to face the direction where the illuminance is highest according to the time identified by the timer.

As a result, a self-running cleaner that can have the operating time further increased and the cost reduced can be provided.

The self-running cleaner set forth above preferably includes a timer identifying the time. Furthermore, the second control device preferably includes a device controlling the device for travel at the time determined in advance as when the illuminance exceeds a predetermined value.

As a result, a self-running cleaner that can have the operating time further increased and the cost reduced can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a control block diagram of a cleaner according to an embodiment of the present invention.

FIG. 2 represents an appearance of the cleaner according to the present embodiment.

FIG. 3 is a flow chart of the control procedure of the recharging process of the cleaner according to an embodiment of the present invention.

FIG. 4A is indicative of the control unit of the cleaner of the present embodiment determining whether the remaining amount of power is lower than a predetermined amount or not.

FIG. 4B represents the operation of the cleaner of the present embodiment rotating at the current site.

FIG. 4C represents the operation of a camera of the cleaner of the present embodiment detecting a well-lighted site for every predetermined interval of orientation that is constant.

FIG. 4D represents the operation of a solar cell of the cleaner of the present embodiment recharging a storage battery.

### DESCRIPTION OF THE PREFERRED EMBODIMENTS

Embodiments of the present invention will be described hereinafter with reference to the drawings. The same components have the same reference character allotted. Their designation and function are also identical. Therefore, detailed description thereof will not be repeated.

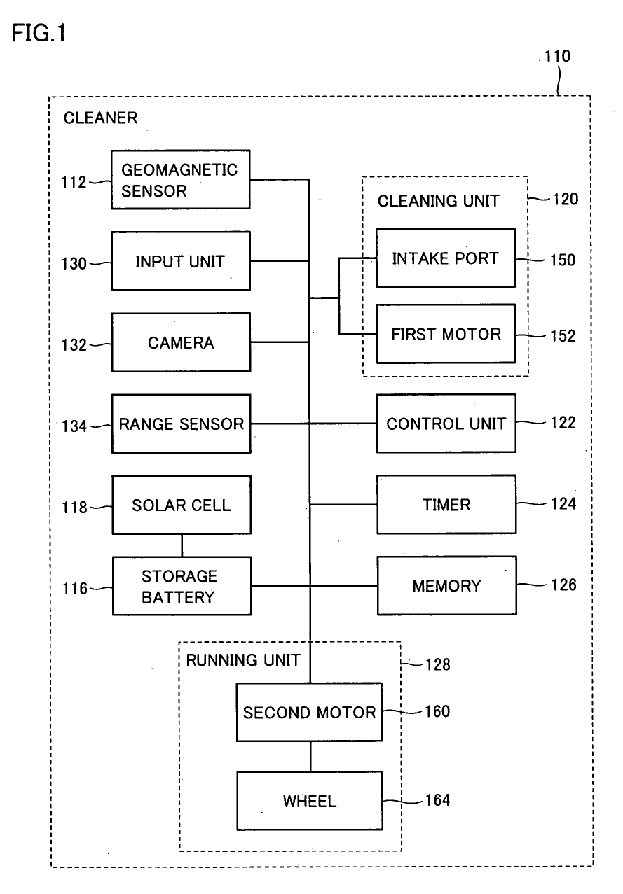

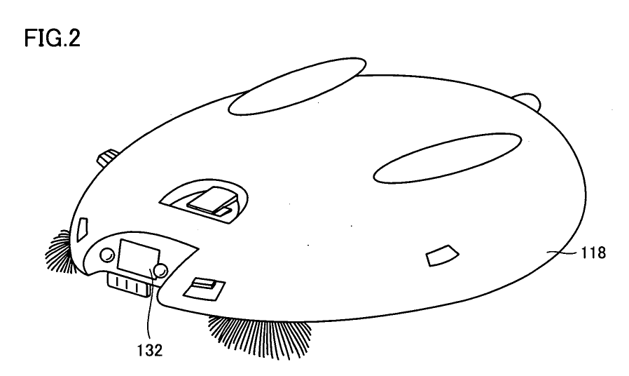

Referring to FIG. 1, a cleaner 110 according to the present embodiment includes a geomagnetic sensor 112, a storage battery 116, a solar cell 118, a cleaning unit 120, a control unit 122, a timer 124, a memory 126, a running unit 128, an input unit 130, a camera 132, and a range sensor 134. It is appreciated from FIG. 2 that camera 132 is provided at the front of cleaner 110. Solar cell 118 is attached to the surface of cleaner 110. A rolling brush in association with an intake port 150 is attached at the bottom of cleaner 110.

Geomagnetic sensor 112 detects the density of the magnetic flux generated by the geomagnetism corresponding to respective directions. Storage battery 116 supplies power consumed by cleaning unit 120. Solar cell 118 converts the light energy into direct current power. Solar cell 118 recharges storage battery 116 by the converted direct current power. In the present embodiment, solar cell 118 is attached on cleaner 110. Storage battery 116 and solar cell 118 are respectively provided in plurality. The plurality of solar cells 118 are connected to storage batteries 116, respectively. One solar cell will not be connected to a plurality of storage batteries. Storage battery 116 is connected in series with cleaning unit 120 and running unit 128. Cleaning unit 120 vacuums up the dust and dirt on the floor. Control unit 122 controls respective elements of cleaner 110. Control unit 122 also functions to conduct the operation required for control. Timer 124 identifies the time. Memory 126 stores information required for the control of respective elements of cleaner 110. Running unit 128 functions for self-propelling of cleaner 110. As used herein, “self-running” refers to travel based on a program and the like stored in memory 126, and does not include any externally applied operation towards cleaner 110. Input unit 130 accepts the user's manipulation. Camera 132 photographs a suspicion person when in a security watching mode (cleaner 110 of the present embodiment is capable of keeping watch during the absence of the user). In the present embodiment, camera 132 employs a CCD (Charge Coupled Device). Camera 132 also functions to photograph the neighborhood of cleaner 110 in a standby mode to output charge according to the illuminance of the reflected light, determined corresponding to the color of the reflected light around cleaner 110 (that is, a device detecting illuminance). Range sensor 134 detects the distance between cleaner 110 and an obstacle. In the present embodiment, range sensor 134 employs a CCD.

Cleaning unit 120 includes an intake port 150 and a first motor 152. Dust and dirt are drawn in by suction through intake port 150. First motor 150 generates the air flow required for the suction of dust and dirt.

Running unit 128 includes a second motor 160 and a wheel 164. Second motor 160 consumes power to drive the rotor. Wheel 164 translates the torque of the rotor to the floor. Accordingly, cleaner 110 runs on the floor. In the present embodiment, two of wheels 164 are provided, which rotate independent of each other. Accordingly, cleaner 110 can make a turn or rotate at the current site in addition to moving frontward and backward. Two of second motors 160 are incorporated to realize such function. Second motor 160 drives the rotor at an arbitrary speed of rotation under PWM (Pulse Width Modulation) control through control unit 122. Similarly, second motor 160 drives the rotor in an arbitrary direction under PWM control through control unit 122.

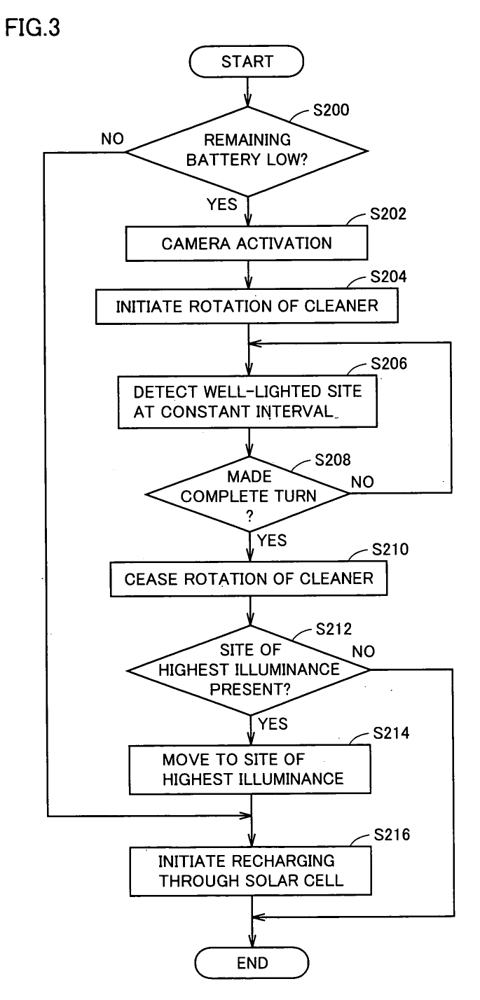

Referring to FIG. 3, the program executed by cleaner 110 of the present embodiment provides control set forth below in association with the recharging process by solar cell 118.

At step 200 (step abbreviated as S hereinafter), control unit 122 determines whether the remaining amount of power output by storage battery 116 is lower than a predetermined amount or not. In the present embodiment, this determination is made based on whether the terminal voltage of storage battery 116 is below a predetermined value or not. When determination is made that the remaining amount of power is below a predetermined amount (YES at S200), control proceeds to S202, otherwise (NO at S200), control proceeds to S216.

At S202, control unit 122 activates camera 132. Specifically, control unit 122 turns on the switch of circuitry that supplies power to camera 132.

At S204, control unit 122 causes cleaner 110 to rotate at the current site. This rotating direction at the current site is horizontal. Specifically, control unit 122 controls running unit 128 such that cleaner 110 rotates horizontally under PWM control. Accordingly, camera 132 fixed to cleaner 110 detects the illuminance of a plurality of sites.

At S206, camera 132 detects the average brightness of the photographed range. This brightness is output as the average value of the signals output from camera 132 to represent an image. In the present embodiment, camera 132 constantly outputs a signal until the power is turned off after being activated. Control unit 122 has the signal output from camera 132 stored in memory 126 at every increase of a predetermined angle from the current direction with respect to the initial direction. Accordingly, camera 132 detects a well-lighted site for every predetermined interval of orientation. This predetermined interval is a constant value.

At S208, control unit 122 determines whether cleaner 110 has made a complete turn based on the number of signals output with respect to second motor 160. When determination is made that cleaner 110 has made a complete turn (YES at S208), control proceeds to S210, otherwise (NO at S208), control proceeds to S206. At S210, control unit 122 ceases output of a signal with respect to second motor 160. Accordingly, cleaner 110 stops its rotation.

At S212, control unit 122 determines, based on the value of the signal output from camera 132, whether there is a site most well-lighted, i.e. determines whether the difference between the maximum value and the minimum value of the signals output from camera 132 exceeds a predetermined threshold value. When determination is made that there is a site most well-lighted (YES at S212), control proceeds to S214, otherwise (NO at S12), the process ends.

At S214, control unit 122 identifies the site most well-lighted based on the value of the signal output from camera 132. Upon identification of the site of highest light, control unit 122 controls running unit 128 such that cleaner 110 moves in the direction of the site most well-lighted. Accordingly, control unit 122 controls running unit 128, based on the illuminance detected by camera 132, so as to move to the site where illuminance is highest among the sites where illuminance has been detected by camera 132.

During the travel operation, control unit 122 monitors the transition of values constantly output from camera 132. When the value output from camera 132 attains the peak, control unit 122 ceases control of running unit 128. Accordingly, cleaner 110 is capable of moving to the site of highest light.

At S216, solar cell 118 converts the light energy into power. Storage battery 116 accumulates the power. Thus, storage battery 116 is recharged.

An operation of cleaner 110 will be described hereinafter based on the configuration and flow chart set forth above.

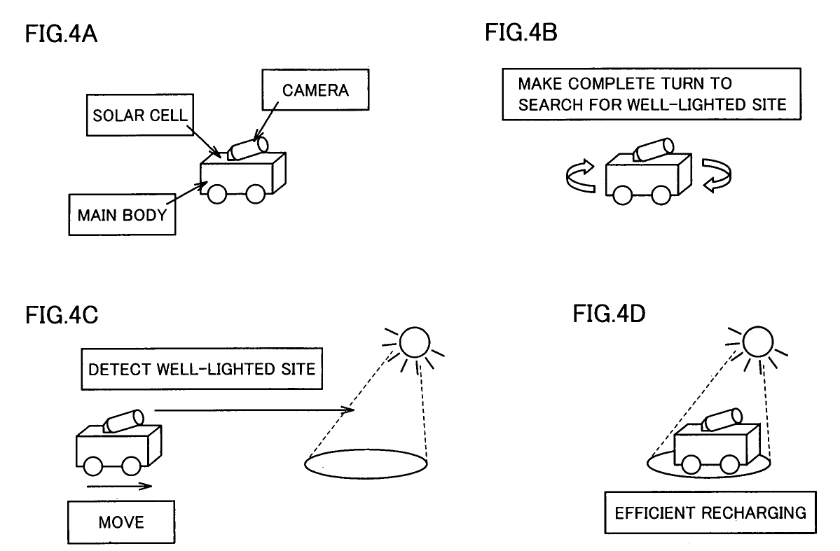

It is to be noted that the appearance of cleaner 110 is depicted theoretically in FIG. 4A. In FIG. 4A, “main body” refers to the body of cleaner 110, excluding solar cell 118 and camera 132. Control unit 122 determines whether the remaining amount of power output from storage battery 116 is below a predetermined amount or not (S200). When determination is made that the remaining amount of power is below a predetermined amount (YES at S200), control unit 122 activates camera 132 (S202). Upon activation of camera 132, control unit 122 causes cleaner 110 to rotate at the current site (S204). FIG. 4B corresponds to this operation. Upon initiation of rotation of cleaner 110 at the current site, camera 132 detects a well-lighted site for every predetermined interval of orientation (S206). FIG. 4C corresponds to this operation. Upon detection of a well-lighted site, control unit 122 determines whether cleaner 110 has made a complete turn based on the number of signals output to second motor 160 (S208). Eventually, determination is made that cleaner 110 has made a complete turn (YES at S208). Control unit 122 ceases the output of a signal to second motor 160. Accordingly, cleaner 110 stops its rotation (S210). When the rotation stops, control unit 122 determines whether there is a site most well-lighted (S212). When determination is made that there is a site of highest light (YES at S212), control unit 122 controls running unit 128 such that cleaner 110 moves to the site most well-lighted (S214). Following the travel of cleaner 110 to the site most well-lighted, solar cell 118 recharges storage battery 116 (S216). FIG. 4D corresponds to this operation.

The cleaner of the present embodiment functions to detect a well-lighted site and move to that site by itself Accordingly, the period of time until recharging by a charger can be increased. The operation of recharging through a charger may become unnecessary depending upon the power consumption of the running unit and cleaning unit. There is a further advantage that the recharging efficiency is favorable since the cleaner of the present embodiment conducts recharging at a site where there is light. The camera searching for a well-lighted site can also be used as a camera for security watching or obstacle detection. There is no further need of another dedicated camera. Accordingly, the cleaner of the present embodiment can be implemented at low cost. As a result, a self-running cleaner that can have the operating time further increased and the cost reduced can be provided.

As an alternative to camera 132, range sensor 134 may be used to output charge according to illuminance determined corresponding to the color of reflected light. As mentioned before, both employ a CCD in the present embodiment. Therefore, range sensor 134 may be used as a substitution for camera 132. In the case where range sensor 134 is employed to output charge corresponding to illuminance, cleaner 110 can move to a well-lighted site efficiently since range sensor 134 outputs charge according to illuminance of reflected light from the floor or a nearby wall.

Instead of determining whether cleaner 110 has made a complete turn or not at S208, determination can be made by control unit 122 whether orientation in a plurality of directions where illuminance is increased has been achieved or not in accordance with the time identified by timer 124. For example, when the time identified by timer 124 is 10:00 a.m., the plurality of directions in accordance with the time identified by timer 124 may be directions included in a range from the east direction to the south direction. In general, the “plurality of directions” differ depending upon where cleaner 110 is used. Since camera 132 is fixedly attached to cleaner 110, control unit 122 controls running unit 128 such that camera 132 faces, at the time identified by timer 124, a plurality of directions where illuminance is increased corresponding to the time identified by timer 124. As a result, camera 132 will mainly face the direction of the sun. Therefore, a well-lighted direction can be detected efficiently. As mentioned before, cleaner 110 incorporates a geomagnetic sensor 112 in the present embodiment. Orientation of camera 132 in a plurality of directions corresponding to the time identified by timer 124 can be achieved by geomagnetic sensor 112.

Additionally, at S204, control unit 122 may control running unit 128 such that cleaner 110 is made to rotate at the current site at a time determined in advance as when the illuminance exceeds a predetermined value. For example, control unit 122 may cause cleaner 110 to rotate at the current site at 8:00 a.m. This eliminates the useless operation of cleaner 110 having to move around to search for a well-lighted site during night hours. Thus, solar cell 1 18 can recharge storage battery 116 more efficiently.

It is further preferable to include a gyro sensor instead of geomagnetic sensor 112.

Although the present invention has been described and illustrated in detail, it is clearly understood that the same is by way of illustration and example only and is not to be taken by way of limitation, the spirit and scope of the present invention being limited only by the terms of the appended claims.

1. A self-running cleaner comprising:
a cleaning unit for suction of dust and dirt,
a storage battery supplying power consumed by said cleaning unit,
a solar cell recharging said storage battery,
a device for travel,
a timer identifying time,
a device detecting illuminance through output of charge according to illuminance determined corresponding to a color of reflected light,
a device controlling said device for travel such that said device detecting illuminance faces, at a time determined in advance as when the illuminance exceeds a predetermined value, a plurality of directions where illuminance is increased, according to the time identified by said timer, and
a device controlling said device for travel so as to move, based on illuminance detected by said device detecting illuminance, to a site where illuminance is highest among sites where illuminance is detected by said device detecting illuminance.

2. A self-running cleaner comprising:
a cleaning unit for suction of dust and dirt,
a storage battery supplying power consumed by said cleaning unit,
a solar cell recharging said storage battery,
a device detecting illuminance of a plurality of sites,
a device for travel, and
a first control device for controlling said device for travel so as to move, based on illuminance detected by said device detecting illuminance, to a site where illuminance is highest among sites where illuminance is detected by said device detecting illuminance.

3. The self-running cleaner according to claim 2, wherein said device detecting illuminance comprises a device providing charge according to illuminance of reflected light, and a second control device for controlling said device for travel such that said device providing charge faces a plurality of directions.

4. The self-running cleaner according to claim 3, wherein said illuminance of reflected light includes illuminance determined corresponding to a color of said reflected light.

5. The self-running cleaner according to claim 3, further comprising a timer identifying time, wherein said second control device includes a device controlling said device for travel so as to face a direction where illuminance is increased according to a time identified by said timer.

6. The self-running cleaner according to claim 3, further comprising a timer identifying time, wherein said second control device includes a device controlling said device for travel at a time determined in advance as when the illuminance exceeds a predetermined value.
